(19) United States
(12) Patent Application Publication
(10) Pub. No.: US 2015/0023052 A1
(43) Pub. Date: Jan. 22, 2015

(54) TWO-SIDED LIGHT GUIDE

(71) Applicant: UNIPIXEL DISPLAYS, INC., The Woodlands, TX (US)

(72) Inventor: Dan VAN OSTRAND, The Woodlands, TX (US)

(21) Appl. No.: 13/945,393

(22) Filed: Jul. 18, 2013

(51) Int. Cl. F21V 8/00

(52) U.S. Cl. CPC G02B 6/0055; G02B 6/0035
USPC 362/606; 362/613

(57) ABSTRACT

A multi-display system includes a single, two-sided backlight assembly between the display panels. The two-sided backlight assembly is able to emit light in two light paths generally 180 degrees apart—one light path passes through one of the display panels and another light pass through the other of the display panels. That is, the two-sided light guide assembly emits light out two sides and generally in opposite directions. The two-sided backlight assembly uses lights such as light emitting diodes (LEDs) mounted on the side of a light guide thereby permitting the backlight assembly to be relatively thin. Because a single, thin, two-sided backlight assembly is used, the overall depth of the multi-display system is less than would be the case if two separate backlight assemblies were used.

### CROSS-REFERENCE TO RELATED APPLICATION

N/A.

### BACKGROUND

Backlights are used in displays such as liquid crystal displays (LCDs). Backlights add to the depth of the display. It is desirable to provide multiple LCD panels in a single housing. The panels may be arranged back-to-back to permit viewers on opposite sides of a table, for example, to view each of the displays. Each display, however, has its own backlight and thus the overall depth of such multi-display units is quite large.

### SUMMARY

In some embodiments, a two-sided light guide assembly that emits light out two sides of the assembly includes a light guide having a pair of opposing sides. The light guide assembly also includes a first light extraction layer provided on one side of the light guide. The first light extraction layer has light extraction features arranged in a first direction. A second light extraction layer also is provided on the other side of the light guide. The second light extraction layer has light extraction features arranged in a second direction orthogonal to the first direction. The light guide assembly also includes a first plurality of light sources provided along a third side of the light guide orthogonal to the pair of opposing sides and a second plurality of light sources provided along a fourth side of the light guide orthogonal to the pair of opposing sides and to the third side. Light from only the first plurality of light sources is extracted out the first light extraction layer and light from only the second plurality of light sources is extracted out the second light extraction layer.

In some embodiments, a two-sided light guide assembly that emits light out two sides of the assembly includes a light guide having a pair of opposing sides. The assembly includes a first light extraction layer provided on one side of the light guide. The first light extraction layer has a first plurality of light extraction features and a reflective material in interstitial spaces between the first plurality of light extraction features. A second light extraction layer also is provided on the other side of the light guide. The second light extraction layer has a second plurality of light extraction features and a reflective material in interstitial spaces between the second plurality of light extraction features. A first plurality of light sources is provided along a third side of the light guide orthogonal to the pair of opposing sides and a second plurality of light sources provided along a fourth side of the light guide orthogonal to the pair of opposing sides and to the third side. Light from only the first plurality of light sources is extracted out the first light extraction layer and light from only the second plurality of light sources is extracted out the second light extraction layer. The reflective material is not in contact with the light guide.

Yet other embodiments are directed to a monitor assembly including a two-sided light guide assembly that includes a light guide and first and second light extraction layers positioned on opposing sides of the light guide. Each light extraction layer comprises a plurality of light extraction features configured to cause light to be extracted from the light guide. The monitor assembly includes a first display panel configured to receive light extracted from the light guide by the first light extraction layer and a second display panel configured to receive light extracted from the light guide by the second light extraction layer. A reflective material is provided in interstitial spaces between the light extraction features of each of the first and second light extraction layers. The reflective material not in contact with the light guide. Light is extractable out one light extraction layer independent of the other light extraction layer.

### BRIEF DESCRIPTION OF THE DRAWINGS

For a detailed description of exemplary embodiments of the invention, reference will now be made to the accompanying drawings in which:

FIG. 1 shows a multi-display system including a two-sided backlight assembly in accordance with various embodiments;

FIG. 2 depicts the two-sided backlight assembly in accordance with various embodiments;

FIG. 3 shows a close-up view of part of a light extraction layer in accordance with various embodiments;

FIG. 4 shows an exploded view of the light guide assembly showing the orientation of the light extraction features on the various light extraction layers;

FIGS. 5 and 6 show examples of light extraction layers;

FIG. 7 illustrates how light is extracted out of the light extraction layers; and

FIG. 8 illustrates reflective material provided in the interstitial spaces between light extraction features.

The drawings are not drawn to scale.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In accordance with various embodiments, a multi-display system is disclosed that includes a single, two-sided backlight assembly between display panels facing opposing directions. The two-sided backlight assembly is able to emit light in two light paths generally 180 degrees apart—one light path passes through one of the display panels and another light pass through the other of the display panels. That is, the two-sided light guide assembly emits light out two sides and generally in opposite directions. The two-sided backlight assembly uses lights such as light emitting diodes (LEDs) mounted on the side of a light guide thereby permitting the backlight assembly to be relatively thin. Because a single, thin, two-sided backlight assembly is used, the overall depth of the multi-display system is less than would be the case if two separate backlight assemblies were used.

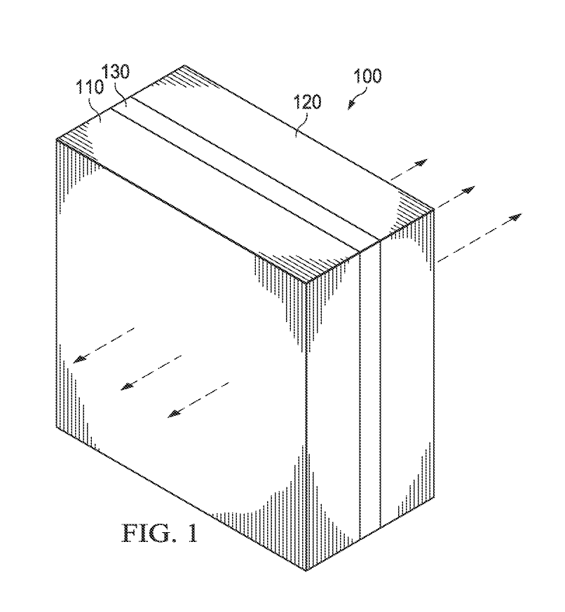

FIG. 1 shows an example of a multi-display system 100 in accordance with various embodiments. The example of the display system 100 shown in FIG. 1 includes a pair of display panels 110 and 120. Display panels 110 and 120 preferably are liquid crystal display (LCD) panels, but can be other than LCD panels in other implementations. The display panels 110, 120 preferably are arranged back-to-back so as to be viewable from opposite sides of the display system.

FIG. 1 also depicts a two-sided light guide assembly 130 sandwiched between the two display panels. The two-sided light guide assembly 130 causes light to be emitted out opposites of the assembly and through each of the display panels.

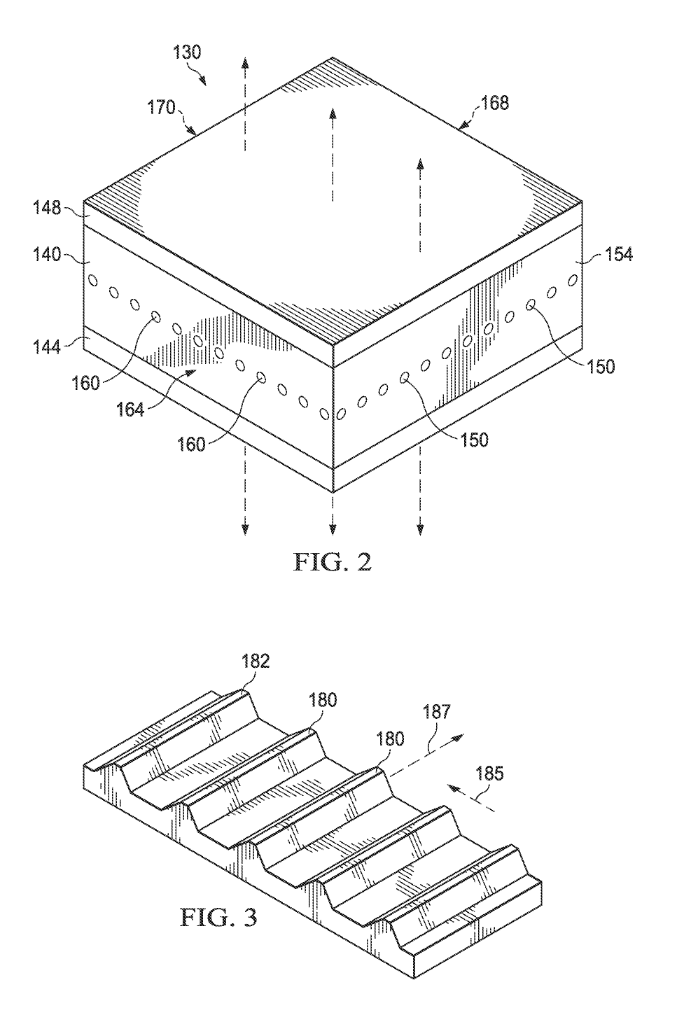

FIG. 2 shows an example of the two-sided light guide assembly 130. As shown, the light guide assembly includes a light guide 140 and a pair of light extraction layers 144 and 148 provided on opposite sides of the light guide 140. The light guide 140 preferably is made of plastic or other suitable material. The light guide 140 generally comprises six sides. The light extraction layers 144 and 148 are provided on two sides and preferably opposing sides of the light guide. The other four sides are designated as 154, 164, 168, and 170 and generally are orthogonal to the sides on which the extraction layers 144, 148 are provided and orthogonal to each other.

The extraction layers 144 and 148 may be films that are adhered to the light guide 140. Alternatively, the extraction layers may be formed directly on the light guide 140.

Two pluralities of light sources (preferably LEDs) are provided along at least two of sides 154, 164, 168, and 170. If only two sides of the light guide are used for light sources, the two sides preferably are orthogonal to each other. As shown in FIG. 2, light sources 150 are provided on side 154 of the light guide, and light sources 160 are provided along side 164. Light sources also can be provided along either or both of the other sides 168 and 170 as desired. If light sources are provided on three or four of sides 154, 164, 168, and 170, then the light sources are still considered to include two pluralities of light sources based on their use as explained. The light sources on opposite sides represent one plurality of light sources and, if all four sides have light sources, the light sources on the other opposite set of sides represent another plurality of light sources.

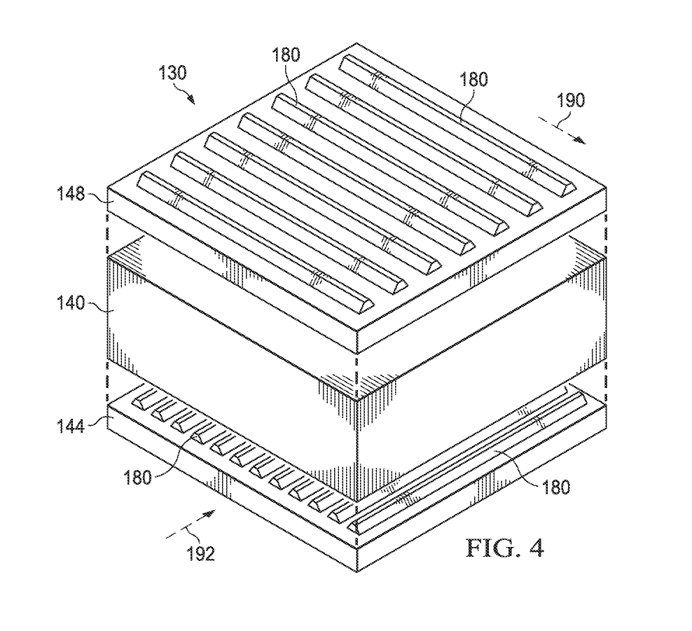

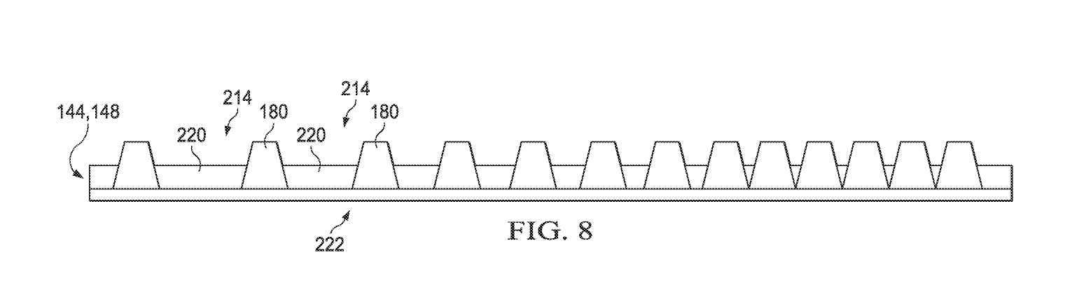

FIG. 3 shows a close-up view of one of the light extraction layers 144, 148. Each extraction layer includes multiple linear light extraction features 180 provided in a parallel fashion as shown. The cross-sectional shape of each light extraction feature 180 generally may be trapezoidal, but can be other than trapezoidal in other embodiments. The tips 182 of each light extraction feature 180 contact the light guide 140 and cause light to be extracted from the light guide and through the extraction layer. A display panel 110, 120 is provided on or near the opposing side 222 (FIG. 8) of the light extraction layer and receives the light emitted by the light guide assembly.

The light extraction features 180 will only extract light inside the light guide 140 that is transmitted in a direction generally normal to the long dimension of the light extraction features (e.g., direction 185 in FIG. 3). Light in the orthogonal direction 187 (parallel to the long dimension of the light extraction features) is not caused to be extracted out of the light guide by the light extraction features 180.

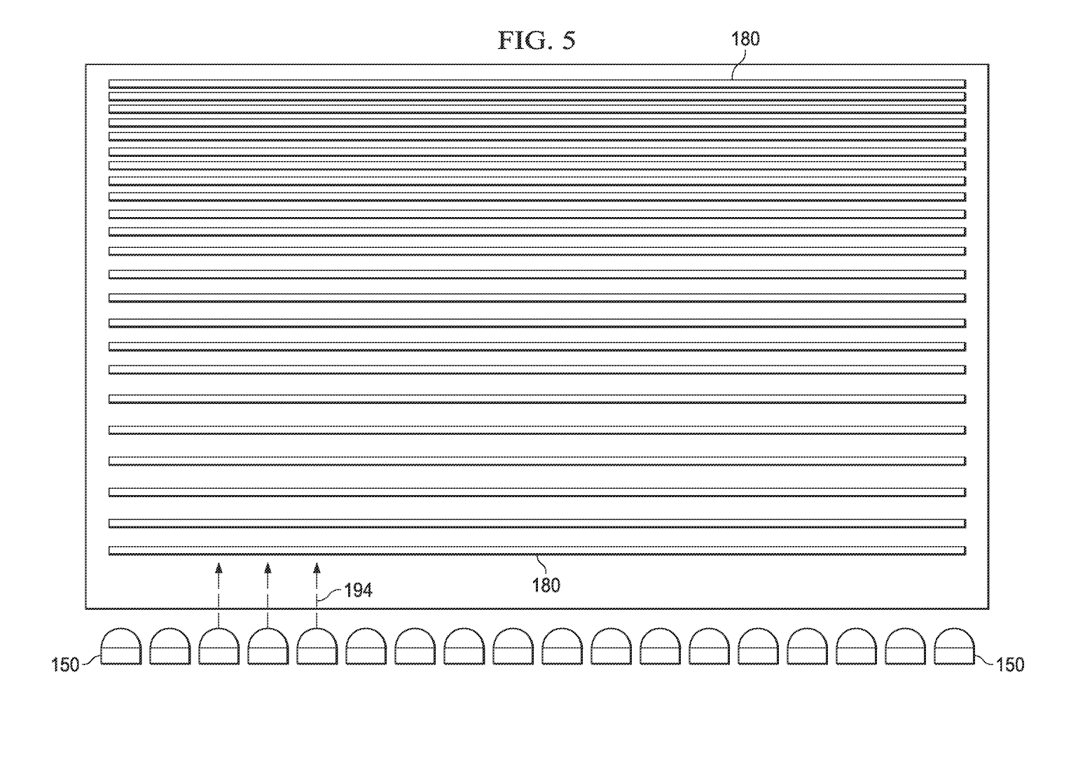

Preferably, the light extraction layers 144, 148 are provided on opposing sides of the light guide 140 so that the light extraction features of one light extraction layer are arranged in a direction orthogonal to the direction of the light extraction features of the other light extraction layer. FIG. 4 shows an exploded view of a light guide assembly 130. Light extraction layer 148 is shown above the light guide 140 and has light extraction features 180 extending in one direction 190. Light extraction layer 144 below the light guide 140 has its light extraction features 180 extending in an orthogonal direction 192 as shown.

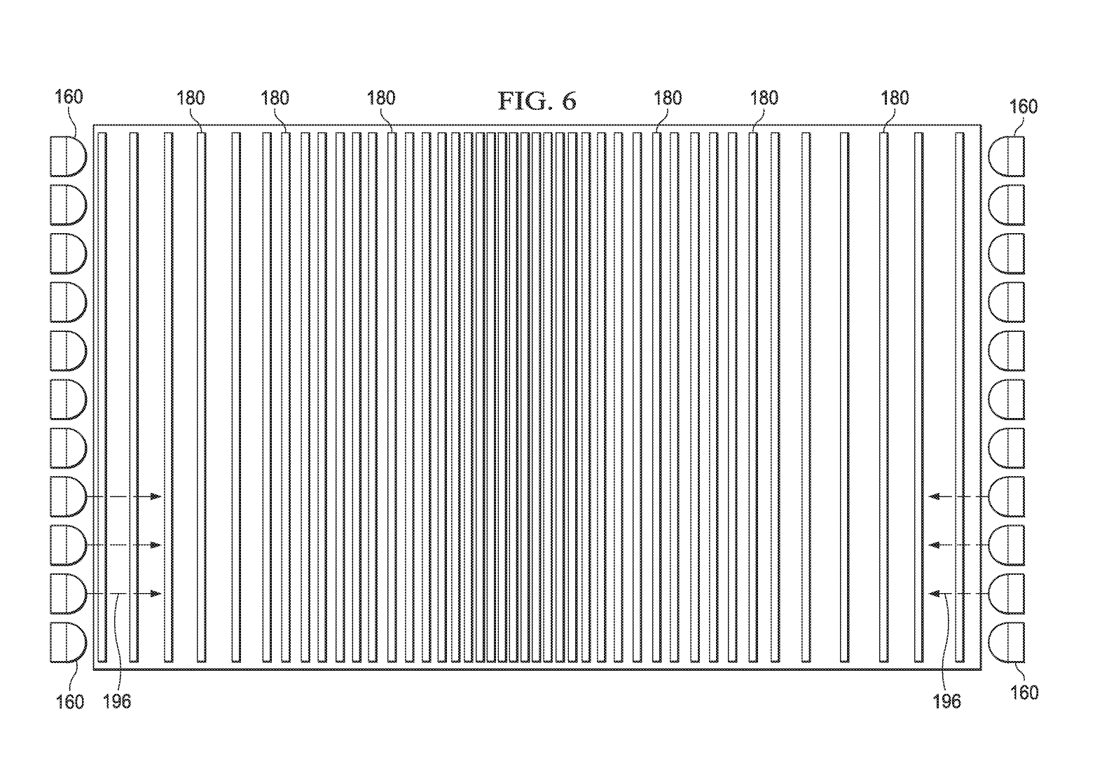

Referring again to FIG. 2, the light guide assembly has light sources 150, 160 along two, three or four sides of the light guide 140. Each plurality of light sources 150, 160 injects light into the light guide 140 in directions generally orthogonal to each other. FIGS. 5 and 6 illustrate the direction of light travel within the light guide in relation to the orientation of the light extraction features.

In FIG. 5, light sources 150 are provided on one side of the light guide and inject light into the light guide in the direction depicted by arrows 194. As depicted in FIG. 5, the light extraction features 180 in one of the light extraction layers 144, 148 are arranged orthogonal to the direction 194 of light travel from one plurality of light sources. Those particular light extraction features will cause the light to be extracted from the light guide. The light extraction features in the other light extraction layer (not shown in FIG. 5) oriented in a direction parallel to light path 194 will not extract that light from the light guide.

In FIG. 5, light sources 150 are provided on only one side of the light guide. To ensure a uniform light distribution from the light guide, the light extraction features 180 preferably are distributed farther apart nearer the light sources and closer together farther from the light sources—that is, a non-uniform distribution of light extraction features.

FIG. 6 shows an example in which light sources 160 are provided on opposing sides of the light guide. Light from the light sources 160 extend generally in a direction 196 through the light guide 140. The light extraction features shown in FIG. 6 are oriented in a direction generally orthogonal to the direction 196 of light travel. As such, the light extraction features shown in FIG. 6 will extract the light from the light guide.

The plurality of light sources 150 may be provided on one side or two opposing sides of the light guide 140. Similarly, the plurality of light sources 160 also may be provided on one or two opposing sides. Further, one plurality of light sources may have light sources on only one side while the other plurality of light sources may be on two sides.

In the example of FIG. 6, because light sources 160 are provided on opposing sides of the light guide 140, to maintain uniform brightness across the light guide, the light extraction features 180 in FIG. 6 preferably are distributed farther apart nearer the light sources 160 and closer together farther from the light sources (i.e., towards the middle). Thus, the light extraction features of FIG. 6 are arranged in a non-uniform fashion.

In general, two sets of light sources are provided which inject light into the light guide 140 in orthogonal directions. Two sets of light extraction features 180 are provided on light extraction layers 144, 148 on opposing sides of the light guide. The two sets of light extraction features are oriented orthogonal to each other. Thus, light from only one set of light sources (i.e., light sources on only a single side of the light guide or on opposing sides) is extracted out one of the light extraction layers, while light from only the other set of light sources is extracted out the other light extraction layer. For example, light only from light sources 160 may be extracted out of light extraction layer 148, while light only from light sources 150 may be extracted out of light extraction layer 144.

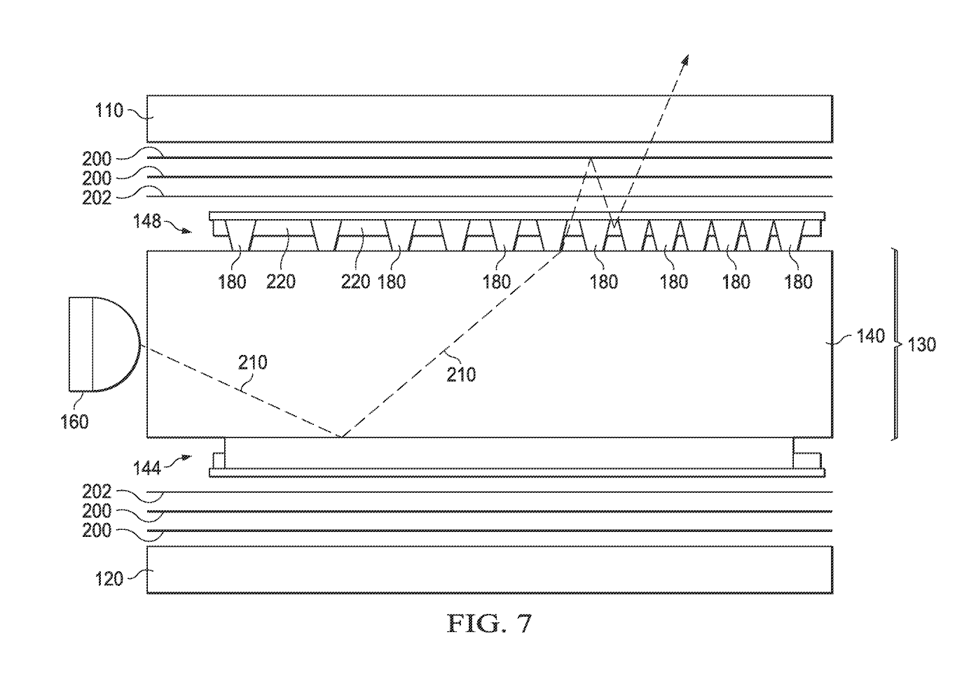

FIG. 7 shows an example of how a light ray is extracted out of the light guide by a light extraction feature. The display system shown in FIG. 7 includes a light guide 140, light extraction layers 144 and 148, and display panels 110 and 120. Also included are brightness enhancement films (BEF) 200 and diffusers 202. A BEF helps increase the brightness of an LCD panel by focusing light generated by the two-sided light guide assembly 130. A diffuser helps to evenly distribute light.

The light extraction features 180 on light extraction layer 148 are oriented orthogonal to the direction light travels in the light guide 140 from light source 160 and cause light from light source to be extracted from the light guide 140. The light extraction features on light extraction layer 144 are oriented parallel to the direction of light travel from light source 160 and thus do not extract light from light source 160. A light ray 210 is depicted. The light ray reflects off the bottom surface of the light guide and encounters a light extraction feature 180. The relative difference in indices of refraction of the light guide 140 and light extraction features 180 is such that light passes from the light guide and into the light extraction feature 180, reflects off a side surface of the light extraction feature, passes through the diffuser 202, reflects off BEF 200, reflects off a reflection layer (discussed below) impregnated into the light extraction layer and finally through the LCD panel 110. The same process occurs for light extraction layer 144 but with the orthogonally arranged set of light sources 150.

Each set of light sources 150 and 160 is independently controllable by controller (e.g., a video controller of a computer).

FIG. 8 shows an example of the light extraction layers 144, 148. An interstitial space 214 is defined between adjacent light extraction features 180. Further, a reflective material 220 is provided to partially fill the interstitial spaces 214 of each light extraction layer. The reflective material 220 preferably comprises titanium dioxide (TiO₂), but may comprise other types of material as well. The reflective material on each light extraction layer reflects light inside the light guide to be extracted out of the opposing extraction layer. The light ray 210 in FIG. 7, for example, reflected off the reflective material 220 embedded in light extraction layer 144 to increases the chance that light ray 210 will be extracted out of the light guide 140 by light extraction layer 148 as shown. With each extraction layer 144, 148 having reflective material, a separate reflector is not needed.

As can be seen in FIG. 7, the reflective material 220 in each light extraction layer does not contact the light guide to improve the efficiency of the light extraction function of the light guide assembly.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A two-sided light guide assembly that emits light out two sides of the assembly, comprising:
a light guide having a pair of opposing sides;
a first light extraction layer provided on one side of the light guide, the first light extraction layer having light extraction features arranged in a first direction;
a second light extraction layer provided on the other side of the light guide, the second light extraction layer having light extraction features arranged in a second direction orthogonal to the first direction; and
a first plurality of light sources provided along a third side of the light guide orthogonal to the pair of opposing sides; and
a second plurality of light sources provided along a fourth side of the light guide orthogonal to the pair of opposing sides and to the third side;
wherein light from only the first plurality of light sources is extracted out the first light extraction layer and light from only the second plurality of light sources is extracted out the second light extraction layer.

2. The two-sided light guide assembly of claim 1 wherein at least one of the first and second light extraction layers comprises a reflective material in interstitial spaces between the light extraction features, and said reflective material is not in contact with the light guide.

3. The two-sided light guide assembly of claim 2 wherein the reflective material comprises titanium dioxide.

4. The two-sided light guide assembly of claim 1 wherein both of the first and second light extraction layers comprise a reflective material in interstitial spaces between the light extraction features, and said reflective material is not in contact with the light guide.

5. The two-sided light guide assembly of claim 1 wherein said first plurality of light sources includes a plurality of light sources provided along a fifth side opposite the third side.

6. The two-sided light guide assembly of claim 5 wherein said second plurality of light sources includes a plurality of light sources provided along a sixth side opposite the fourth side.

7. The two-side light guide assembly of claim 1 wherein the first plurality of light sources is operable independently of the second plurality of light sources.

8. A two-sided light guide assembly that emits light out two sides of the assembly, comprising:
a light guide having a pair of opposing sides;
a first light extraction layer provided on one side of the light guide, the first light extraction layer having a first plurality of light extraction features and a reflective material in interstitial spaces between the first plurality of light extraction features;
a second light extraction layer provided on the other side of the light guide, the second light extraction layer having a second plurality of light extraction features and a reflective material in interstitial spaces between the second plurality of light extraction features; and
a first plurality of light sources provided along a third side of the light guide orthogonal to the pair of opposing sides; and
a second plurality of light sources provided along a fourth side of the light guide orthogonal to the pair of opposing sides and to the third side;
wherein light from only the first plurality of light sources is extracted out the first light extraction layer and light from only the second plurality of light sources is extracted out the second light extraction layer; and
wherein said reflective material is not in contact with the light guide.

9. The two-sided light guide assembly of claim 8 wherein the first plurality of light extraction features is arranged in a first direction and the second plurality of light extraction features is arranged in a second direction orthogonal to the first direction.

10. The two-sided light guide assembly of claim 8 wherein the reflective material comprises titanium dioxide.

11. The two-sided light guide assembly of claim 8 wherein said first plurality of light sources includes a plurality of light sources provided along a fifth side opposite the third side.

12. The two-sided light guide assembly of claim 11 wherein said second plurality of light sources includes a plurality of light sources provided along a sixth side opposite the fourth side.

13. The two-side light guide assembly of claim 8 wherein the first plurality of light sources is operable independently of the second plurality of light sources.

14. A monitor assembly, comprising:
a two-sided light guide assembly comprising a light guide and first and second light extraction layers positioned on opposing sides of the light guide, each light extraction layer comprising a plurality of light extraction features configured to cause light to be extracted from the light guide;
a first display panel configured to receive light extracted from the light guide by the first light extraction layer;
a second display panel configured to receive light extracted from the light guide by the second light extraction layer;
a reflective material in interstitial spaces between the light extraction features of each of the first and second light extraction layers, said reflective material not in contact with the light guide;
wherein light is extractable out one light extraction layer independent of the other light extraction layer.

15. The monitor assembly of claim 14, further comprising:
a first plurality of light sources provided along a third side of the light guide orthogonal to the pair of opposing sides; and
a second plurality of light sources provided along a fourth side of the light guide orthogonal to the pair of opposing sides and to the third side and;
wherein light is extracted out the first light extraction layer only from the first plurality of light sources and light is extracted out the second light extraction layer only from the second plurality of light sources.

16. The monitor assembly of claim 15, wherein the first plurality of light sources is operable independent of the second plurality of light sources.

17. The monitor assembly of claim 14 wherein the plurality of light extraction features of each light extraction layer is arranged orthogonally to each other.

18. The monitor assembly of claim 14 wherein the reflective material comprises titanium dioxide.
